(19) United States
(12) Patent Application Publication
(10) Pub. No.: US 2015/0276088 A1
(43) Pub. Date: Oct. 1, 2015

(54) PRESSURE REGULATING VALVE AND METHOD OF ADJUSTING DAMPING OF THE SAME

(71) Applicant: Hamilton Sundstrand Corporation, Charlotte, NC (US)

(72) Inventor: Matej Rutar, Manchester, CT (US)

(73) Assignee: Hamilton Sundstrand Corporation, Charlotte, NC (US)

(21) Appl. No.: 14/224,598

(22) Filed: Mar. 25, 2014

(51) Int. Cl. F16K 47/02; F16K 11/078

(52) U.S. Cl. CPC F16K 47/023; F16K 11/078

(57) ABSTRACT

A pressure regulating valve includes a housing having a cavity therein with at least a first port, a second port and a third port in fluidic communication with the cavity, and a spool movable within the cavity. The spool separates the cavity into at least a first space and a second space, the first port and the second port are in alterable fluidic communication with the first space with movement of the spool altering a flow area connecting the first port with the second port. The third port connects to the second space through a variable flow area opening that is configured to alter a rate of movement of the spool.

### BACKGROUND OF THE INVENTION

Pressure regulating devices are used in pressurized fluid systems for many purposes. The responsiveness or damping of such devices is often set to suit the needs of the system in which they are deployed. Usually high damping is desired when large pressure differentials exist across a pressure regulating device and conversely little damping is desired when there small pressure differential exist across the pressure regulating device. For systems that have a wide range in pressure differentials the damping is typically set at a level to compromise between the highest and lowest anticipated pressure differentials.

### BRIEF DESCRIPTION OF THE INVENTION

Disclosed herein is a pressure regulating valve. The valve includes a housing having a cavity therein with at least a first port, a second port and a third port in fluidic communication with the cavity, and a spool movable within the cavity. The spool separates the cavity into at least a first space and a second space, the first port and the second port are in alterable fluidic communication with the first space with movement of the spool altering a flow area connecting the first port with the second port. The third port connects to the second space through a variable flow area opening that is configured to alter a rate of movement of the spool.

Further disclosed herein is a method of adjusting damping of a pressure regulating valve. The method includes adjusting an effective flow area of an opening in a port fluidically connecting a space defined between a spool movably engaged within a cavity in a housing of the pressure regulating valve wherein the spool position within the cavity in the housing controls a pressure differential across the pressure regulating valve.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a cross sectional view of a pressure regulating valve disclosed herein;

FIG. 2A depicts a side view of an embodiment of a movable member employable in the pressure regulating valve of FIG. 1;

FIG. 2B depicts a side view of another embodiment of a movable member employable in the pressure regulating valve of FIG. 1; and

FIG. 2C depicts a side view of another embodiment of a movable member employable in the pressure regulating valve of FIG. 1.

### DETAILED DESCRIPTION OF THE INVENTION

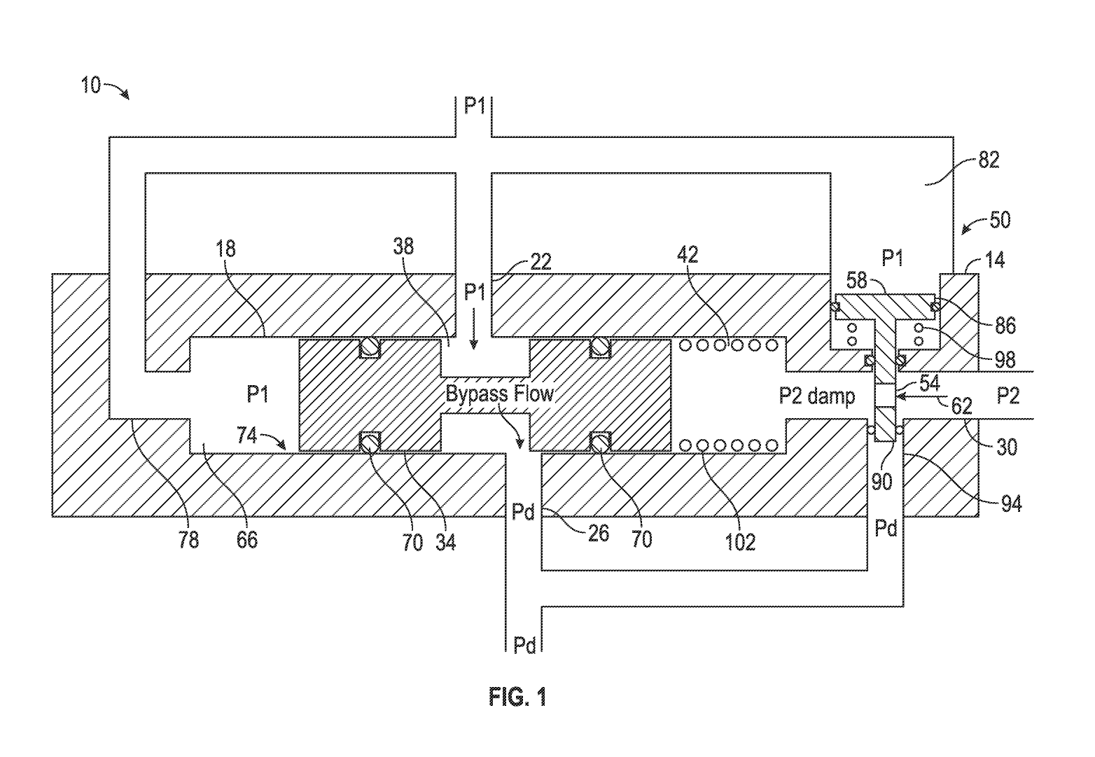

Referring to FIG. 1 a schematical view of an embodiment of a pressure regulating valve (PRV) disclosed herein is illustrated at 10. The PRV 10 includes a housing 14 having a cavity 18 therein. The cavity 18 is in fluidic communication with at least a first port 22, a second port 26, and a third port 30. A spool 34 is movable within the cavity 18 and separates the cavity 18 into at least a first space 38 and a second space 42. The first port 22 and the second port 26 are in alterable fluidic communication with each other through the first space 38 in response to movement of the spool 34. More specifically, flow area fluidically connecting the first port 22 to the second port 26 is altered in response to movement of the spool 34 relative to the housing 14. The third port 30 is fluidically connected to the second space 42 through a variable flow area device 50. The variable flow area device 50 alters an effective flow area of opening 54 between the second space 42 and the third port 30. The altering of area of the opening 54 alters a rate of movement of the spool 34 within the cavity 18, by varying the restriction to fluid flow through the area of the opening 54. This altering of the rate of movement of the spool 34 creates variable damping of the PRV 10. As such, the variable flow area device 50 serves as a variable damper for the pressure regulating valve 10.

The variable flow area device 50 includes a member 58 having at least one passageway 62 therethrough in operable communication with the third port 30. The member 58 is movable relative to the third port 30 to alter an effective flow area of the opening 54. Movement of the member 58 can be controlled in various ways such as hydraulic, pneumatic and electrical, for example. If electrically controlled the actuator could use a solenoid or a stepper motor (not illustrated) to move the member 58.

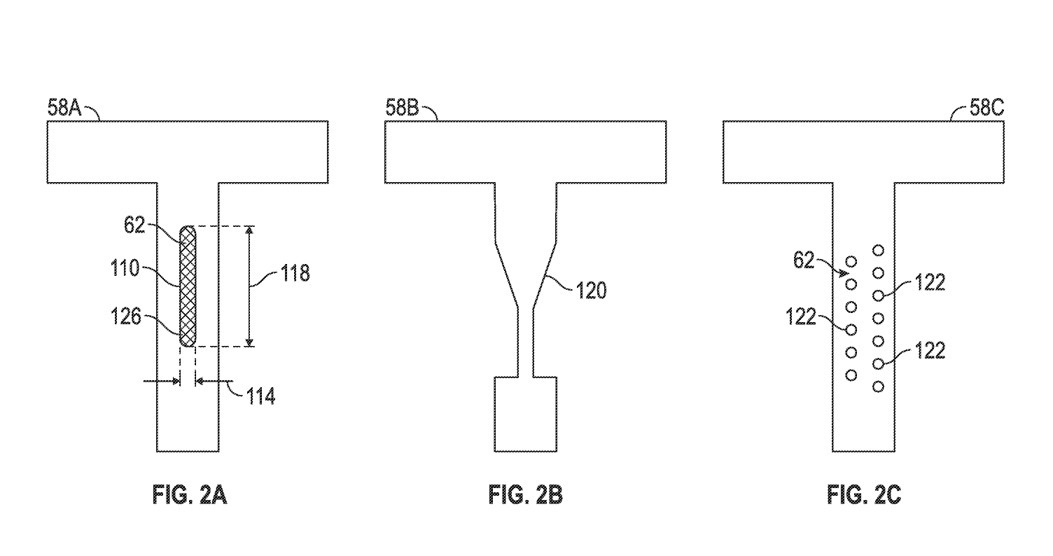

The member 58 illustrated is a piston that is moved hydraulically and automatically as will be described hereunder. The cavity 18 also includes a third space 66 that is separated from the first space 38 and the second space 42 by the spool 34. The spool 34 may include optional seals 70 to slidably sealingly engage walls 74 that define the cavity 18 within the housing 14. A fourth port 78 is fluidically connected to the third space 66, the first port 22, and a chamber 82. The chamber 82 houses at least a first portion 86 of the member 58. A second portion 90 of the member 58 is fluidically connected to a fifth port 94 that is fluidically connected to the second port 26. The first portion 86 and the second portion 90 of the member 58 may be slidably sealingly engaged (via optional seals not shown) with the housing 14 or other structure to allow pressure to build thereagainst to urge movement of the member 58. A biasing member 98 biases the member 58 toward the chamber 82. Another biasing member 102 biases the spool 34 toward the third space 66. Movement of the member 58 in a direction against the biasing member 98 causes a decrease in flow area of the opening 54 by moving a portion of the passageway 62 out of fluidic communication with the third port 30. Additional information on the passageway 62 will be described below with reference to FIGS. 2A-2C.

In the embodiment of FIG. 1 the spool 34 is a piston movable within a cylindrical bore 124 within the housing 14 that defines the cavity 18. Two of the seals 70 are sealingly engaged to the piston 34 within grooves 128. The seals 70 are also slidably sealingly engaged with the walls 74 of the bore 124, thereby separating the spaces 38, 42 and 66 into three separate volumes. This structure results in volume of the second space 42 and the third space being alterable in response to movement of the piston 34 within the bore 124. As the piston moves leftward in the Figure the volume of the second space 42 increases while the volume of the third space 66 decreases. If the bore 124 has a constant diameter, as does the one illustrated, the increase in volume of the second space 42 is offset with a same decrease in volume of the third space 66. Alternate geometries are considered that have different diameters of the bore 124 that would result in different changes in volume between the two spaces 42, 66 relative to movement of the piston 34. Movement of the piston 34 in the opposite direction (rightward in the Figures) reverses the volume changes discussed above. The first space 38 defines a volume that remains constant while the piston 34 is moved since the distance between the seals 70 and the diameter where the seals 70 engage the walls 74 remain constant.

An area of reduced diameter 136 in the piston 34 between the seals 70 defines a flow path between the first port 22 and the second port 26 within the bore 124. A shoulder 140 on the piston 34 between the area of reduced diameter 136 and an area 144 of the piston 34 without a reduced diameter can overlap with the second port 26. The extent of this overlap defines a flow area between the first space 38 and the second port 26 and in the process defines a flow area between the first port 22 and the second port 26. As the overlap increases the flow area between ports 22 and 26 decreases. This reduction in flow area occurs when the piston 34 is moved leftward in the Figure. Conversely, moving the piston 34 rightward reduces overlap of the shoulder 140 and the second port 26 thereby increasing flow area between the first port 22 and the second port 26.

Differential pressure between P1 (pressure in the third space 66) and P2 damp (pressure in the second space 42) creates forces on the spool 34 to move the spool 34 toward the second space 42. Increases in differential pressures across the pressure regulating valve 10 such that P1-P2 damp become greater increase urging force on the spool 34 in a direction to increase flow area between the first port 22 and the second port 26 and thus increase flow through the pressure regulating valve 10 which may be referred to as bypass flow. The biasing member 102 resists movement of the spool 34 in the direction to increase bypass flow and allows for movement of the spool 34 in the reverse direction in response to differential pressure across the pressure regulating valve 10 being altered in the opposite direction as just described.

The volume change in the second space 42, discussed above, requires fluid to flow into or out of the space 42 to avoid a hydraulic lock situation when using a fluid that in substantially incompressible. Since the opening 54 is the only flow path for fluid to flow into and out of the second space 42 the opening 54 creates damping of the movement of the piston 34. As such, the effective flow area of the opening 54 of the variable flow device 50 controls damping of movement of the spool 34, with smaller effective flow areas increasing the damping of such movement by slowing the flow of fluid through opening 54 of the variable flow device 50.

Differential pressure across the variable flow device 50 between P1 and Pd (pressure in the fifth port 94) create urging force on the member 58 to move the member 58. Increases in differential pressures wherein P1-Pd grows causes increases in urging force on the member 58 in a direction toward the fifth port 90. Movement of the member 58 in this direction decreases effective flow area of the variable flow area device 50 thereby increasing damping of movement of the spool 34. This movement is reversible by forces stored in the biasing member 102 when pressure differential across the member 58 are altered in an opposite direction to that just described.

The foregoing structure permits the following operation. Increases in pressure P1, without altering the pressures Pd or P2 damp, for example, will urge movement of both the spool 34 and the member 58. The spool 34 movement is in a direction to increase bypass flow from the first port 22 to the second port 26. The member 58 movement is in a direction to decrease effective flow area of the opening 54 thereby increasing damping on movement of the spool 34. Thus, the greater the flow through the PRV 10 (i.e. bypass flow) the more damped the PRV 10 (additional movement of the spool 34) becomes. The foregoing operation is reversible due to the action of the biasing members 98 and 102. As such, decreases in the pressure P1, without altering Pd and P2 damp, for example, will urge movement of the spool 34 in a direction to decrease bypass flow and movement of the member 58 in a direction to reduce damping of movement of the spool 34. Thus, damping of the PRV 10 is decreased as bypass flow is decreased. Furthermore, both of these changes occur automatically in response to changes in the differential pressures. The PRV 10 can therefore have very little damping and thus very fast response times during certain conditions while being automatically adjusted to have greater damping and thus slower response times during other operating conditions.

Various parameters of the PRV 10 can be set to tailor the alteration in damping that is associated with changes in differential pressures. For example, the ratio of area that pressure P1 acts on the first portion 86 of the member 58 to the area the pressure Pd acts on the second portion 90 of the member 58 can be set as desired. Also the biasing force of the biasing member 98 can be selected to suit each particular application.

Referring to FIGS. 2A-2C, the moveable member 58 can have different physical characteristics that effect how the variable flow device 50 alters the effective flow area of the opening 54 in response to movement of the member 58. The movable member 58A in FIG. 2A for example, includes an elongated slot 110 therethrough that defines the passageway 62. The elongated slot 110 provides a continuously variable effective flow opening 54 in response to movement of the movable member 58A. Having a width 114 of the slot vary over its length 118 could make the change in effective area of the opening 54 be nonlinear with relative to the movement of the movable member 58A. An alternate embodiment of the movable member 58B with a profile 120 in FIG. 2B also provides continuously variable changes in the effective flow area of the opening 54 with movement of the movable member 58B. While in the embodiment of FIG. 2C the movable member 58C employs discrete orifices 122 as the passageway 62 that provides discrete steps of changes in the effective flow area of the opening 54 with movement of the movable member 58C. Additionally, the slot 110 and the orifices 122 can be filled with sintered metal 126 or other permeable matter to provide additional control to the variation in damping associated with movement of the movable members 58A, 58C.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A pressure regulating valve comprising:
a housing having a cavity therein with at least a first port, a second port and a third port in fluidic communication with the cavity; and
a spool movable within the cavity, the spool separating the cavity into at least a first space and a second space, the first port and the second port being in alterable fluidic communication with the first space with movement of the spool altering a flow area connecting the first port with the second port, the third port connecting the second space through a variable flow area opening configured to alter a rate of movement of the spool.

2. The pressure regulating valve of claim 1, wherein the altering of rate of movement of the spool alters a damping of the pressure regulating valve.

3. The pressure regulating valve of claim 1, wherein a flow area of the variable flow area opening is altered by a variable flow area device.

4. The pressure regulating valve of claim 3, wherein the variable flow area device includes a member having at least one passageway in operable communication with the third port.

5. The pressure regulating valve of claim 4, wherein the member is movable relative to the third port to alter an effective flow area of the variable flow area opening.

6. The pressure regulating valve of claim 4, wherein the member is moved hydraulically, pneumatically or electrically.

7. The pressure regulating valve of claim 4, wherein the member is moved automatically.

8. The pressure regulating valve of claim 4, wherein the pressure regulating valve is configured to increase damping as flow area connecting the first port and the second port increases.

9. The pressure regulating valve of claim 4, wherein the alteration in damping is reversible.

10. A method of adjusting damping of a pressure regulating valve, comprising adjusting an effective flow area of an opening in a port fluidically connecting a space defined between a spool movably engaged within a cavity in a housing of the pressure regulating valve wherein the spool position within the cavity in the housing controls a pressure differential across the pressure regulating valve.

11. The method of adjusting damping of a pressure regulating valve of claim 10, further comprising moving a member relative to the port.

12. The method of adjusting damping of a pressure regulating valve of claim 11, further comprising altering a number of orifices in the member that are in fluidic communication with the port.

13. The method of adjusting damping of a pressure regulating valve of claim 11, wherein the moving of the member occurs automatically in response to changes in pressure differential across the pressure regulating valve.

14. The method of adjusting damping of a pressure regulating valve of claim 13, further comprising reducing the effective flow area of the opening in response to increases in pressure differential across the pressure regulating valve.

15. The method of adjusting damping of a pressure regulating valve of claim 11, further comprising moving the member in a direction to increase an effective flow area of the port in response to a decrease in pressure differential across the pressure regulating valve.
